(19) United States
(12) Patent Application Publication
(10) Pub. No.: US 2026/0229620 A1
(43) Pub. Date: Aug. 6, 2026

(54) SMART BATTERY CHARGING FOR BATTERY LONGEVITY AND SWELLING MITIGATION

(71) Applicant: Lenovo (United States) Inc., Morrisville, NC (US)

(72) Inventors: Bouziane Yebka, Morrisville, NC (US); Jeremy R. Carlson, Morrisville, NC (US); Philip J. Jakes, Morrisville, NC (US)

(21) Appl. No.: 19/045,813

(22) Filed: Feb. 5, 2025

(51) Int. Cl. H01M 10/42; H01M 10/44

(52) U.S. Cl. CPC H01M 10/4257; H01M 10/44; H01M 2010/4271; H01M 2220/30

(57) ABSTRACT

In one aspect, a device includes a processor and storage. The storage includes instructions executable by the processor to determine, based on battery usage history data, a first state of charge (SOC) to which to charge a battery, with the first SOC being less than full SOC. The instructions are also executable to, based on the determination, charge the battery to a first voltage corresponding to the first SOC. The first SOC may include both a first charge amount equal to an estimated discharge amount for an upcoming discharge cycle, and a reserve charge amount in excess of the first charge amount. The battery may therefore be charged more than enough for the user to use the battery during the upcoming discharge cycle while still reducing the likelihood of accelerated battery degradation due to the battery being kept at full charge for too long.

### FIELD

The disclosure below relates to technically inventive, non-routine solutions that are necessarily rooted in computer technology and that produce concrete technical improvements. In particular, the disclosure below relates to techniques for smart battery charging for battery longevity and swelling mitigation.

### BACKGROUND

Charging batteries in laptop computers, smartphones, and other types of devices typically involves charging the battery up to a full state of charge (SOC), assuming the battery remains electrically coupled to its charger. As recognized herein, this results in the battery staying at maximum voltage for great lengths of time, which can cause the battery to degrade more quickly at a rate that is dependent in part on the chemistry of the battery. This, in turn, can reduce the total amount of charge cycles the battery has over its lifetime.

Present principles recognize that these problems are being exacerbated by the different types of materials now being included in modern batteries, including silicone anodes and high-voltage cathodes. The material will suffer from stress at high voltage and high state of charge which might not only reduce overall battery longevity and increase battery swelling but also cause acute battery failure.

No adequate solutions currently exist to the foregoing technological problems.

### SUMMARY

Present principles therefore provide systems and methods for charging a battery to a voltage amount that is less than full charge based on an expected battery usage amount for the next discharge cycle. The expected battery usage amount may be determined from battery usage history data. Present techniques thus allow a battery to stay advantageously below full charge as much as possible to increase battery longevity and mitigate battery swelling while still providing enough battery power for the upcoming discharge cycle.

Accordingly, in one aspect, a device includes a battery, a processor system, and storage accessible to the processor system. The storage includes instructions executable by the processor system to execute a trained model to determine, based on battery usage history data, a first state of charge (SOC) to which to charge the battery. The first SOC is less than a full SOC for the battery. The instructions are also executable to, based on the determination, charge cells of the battery to a first voltage corresponding to the first SOC. The first voltage is less than a second voltage corresponding to the full SOC for the battery.

In various examples implementations, the trained model may include a trained pattern recognition model. If desired, the trained model may be trained to recognize battery usage patterns according to time of day and/or day of the week. Additionally or alternatively, the trained model may be trained to recognize battery usage patterns based on application usage patterns. In certain non-limiting examples, the trained model may include an artificial neural network.

In addition, in some instances the trained model may be trained to determine the first SOC to include both of a first charge amount equal to an estimated discharge amount for an upcoming discharge cycle and a reserve charge amount in excess of the first charge amount.

What's more, in some example implementations the instructions may be executable to reduce the SOC of the battery from the first SOC to a second SOC responsive to the battery being connected to a charge circuit for longer than expected during the first charge cycle. In various examples, this may be done by disconnecting the battery from the charge circuit for the battery to discharge via device operation and/or via the application of a parasitic load to consume battery power.

In another aspect, a method includes determining, based on battery usage history data, a first state of charge (SOC) that is less than the full SOC to which to charge a battery. The method also includes, based on the determination, charging the battery to the first SOC but not past the first SOC for a first charge cycle.

In some examples, the method may include executing a model to determine the first SOC. The model may include a feed forward neural network and/or a convolutional neural network.

Also in some examples, the battery usage history data may be related power consumption for Wi-Fi transceiver usage and/or for global positioning system (GPS) transceiver usage. Additionally or alternatively, the battery usage history data may be related to power consumption for gaming usage of a device and/or for job usage of the device.

In still another aspect, an apparatus includes at least one computer readable storage medium (CRSM) that is not a transitory signal. The at least one CRSM includes instructions executable by a processor system to determine, based on battery usage history data, a first voltage that is less than full voltage to which to charge a battery. The instructions are also executable to, based on the determination, charge the battery to the first voltage but not past the first voltage for a first uninterrupted charge cycle.

In certain instances, the instructions may be executable to determine the first voltage as including a reserve charge amount in excess of a first charge amount equal to an estimated discharge amount for an upcoming discharge cycle.

Also in some example instances, the instructions may be executable to execute a pattern recognition model to make the determination.

Further still, in some examples the apparatus may include the battery itself. The battery may be embodied as a battery pack of a laptop computer in one non-limiting instance.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIGS. 2-7 show charts that demonstrate smart charging algorithms that may be implemented consistent with present principles to charge a battery to a target SOC that is less than max SOC;

FIG. 8 illustrates example logic in a flow chart format that may be executed by a device consistent with present principles;

FIG. 9 shows an example of artificial intelligence (AI) architecture for an ML-based model that may be implemented consistent with present principles.

FIG. 10 shows an additional chart demonstrating present principles; and

FIG. 11 shows an example graphical user interface (GUI) that may be presented on a display to enable a user to opt-in to smart battery charging consistent with present principles.

### DETAILED DESCRIPTION

As recognized herein, batteries naturally degrade over time, even when not in use. This type of degradation is influenced by the state of charge (SOC) at which the battery is kept, with high SOCs generally leading to faster battery degradation. Degradation can also occur based on how the battery is charged, used, and maintained. For instance, regularly charging the battery to 100% SOC at maximum charging voltage can significantly impact battery health by accelerating degradation, particularly for modern high-energy-density chemistry batteries.

The detailed description below therefore discusses techniques for increasing battery longevity and for controlling battery swelling. This may be done by decreasing the max charging voltage and time spent at full charge for a given charge cycle. Thus, the battery may be charged to a relatively high voltage only if predicted to be needed for an upcoming discharge cycle, with the battery still maintaining a predefined runtime reserve in some instances in case the user needs more battery power than expected during the upcoming discharge cycle.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS or iOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single-or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a graphics processing unit (GPU), a neural processing unit (NPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C #or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

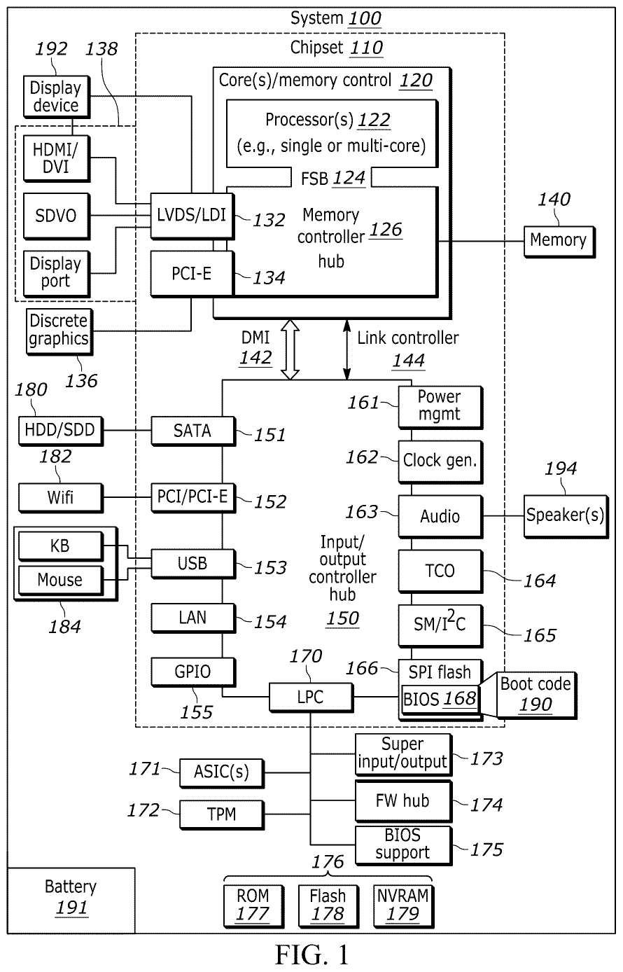

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre®, or notebook computer system, such as ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. For example, the memory controller hub 126 may include a 16-lane (x16) PCI-E port for an external PCI-E-based graphics card (including, e.g., one or more GPUs). An example system may thus include PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Furthermore, the system 100 may also include at least one battery/pack 191 consistent with present principles, with the battery 191 including one or plural battery cells. Each battery cell may include an anode, a cathode, and an electrolyte between the anode and the cathode. The cells may be in jelly roll format. The cells may also be configured in pouch cell format in which the strip(s) of active materials are folded, or in a stacked format if desired. Regardless, the battery cells may be Lithium-ion battery cells, alkaline-based battery cells, acid-based battery cells, and/or other types of battery cells. In one particular instance, the battery 191 may be embodied as a battery pack for a laptop computer or smartphone, though the battery 191 may also be embodied as an electric vehicle battery, solar system battery, or other type of battery.

It is to be understood that an example client device or other machine/computer may include fewer or more features than shown on the system 100 of FIG. 1. In any case, it is to be understood at least based on the foregoing that the system 100 is configured to undertake present principles.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Attention-based architectures or transformer-based architectures may be used. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

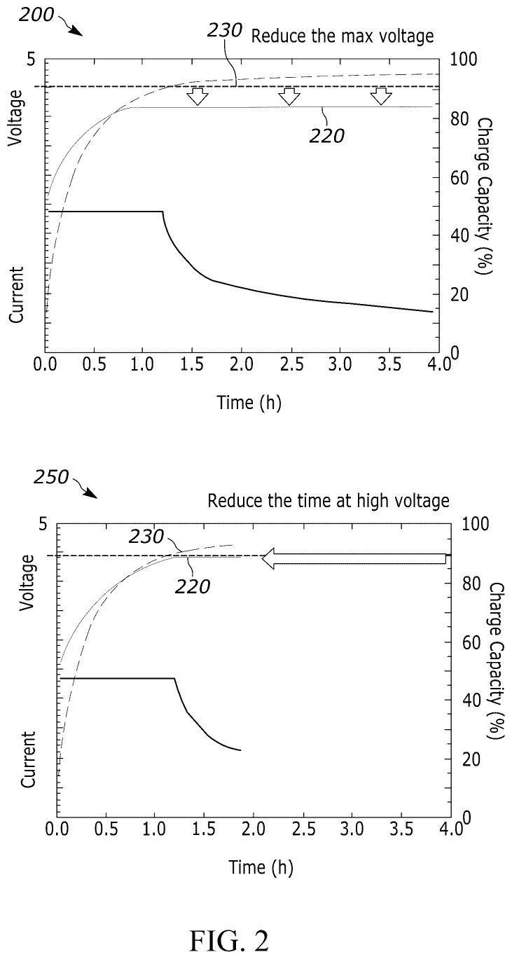

Now in reference to FIGS. 2-7, these figures show charts that demonstrate algorithms that may be implemented consistent with present principles. The algorithms themselves may be stored as computer-readable instructions and may even include the use of artificial intelligence (AI) models in some examples.

Additionally, before going into detail on each of these figures, it is to be generally understood that the associated algorithms for each figure may be executed to determine a “first” or “target” voltage amount to which to charge a battery in a smartphone, laptop computer, or other client device. However, the battery will still not be charged past the target voltage amount, even if the target voltage amount is less than a maximum available/possible voltage level and there is enough charge time remaining to charge the battery to the maximum level or SOC. This may help mitigate cell swelling and increase the useful life of the battery.

The target voltage amount itself may be determined from battery usage history data that indicates past user device-based activities from which patterns can be extracted using AI to then infer a predicted amount of battery power the user would want to run their device during the upcoming discharge cycle. Determining the target voltage amount may include adding a reserve charge amount on top of the amount that is predicted to be used during the upcoming discharge cycle, for example to compensate for unexpected device use, and hence battery drain.

Now in reference to FIG. 2 in particular, two different charts 200, 250 are shown. Each one includes electrical current for the bottom half of the left-side Y axis and voltage for the top half of the left-side Y axis. The right-side Y axis indicates charge capacity as state of charge (SOC) from zero to one hundred percent. Time is represented on the X axis in hours.

Chart 200 illustrates that constant current may be applied during early stages of a given charge cycle to bring cell voltage up to a first/target voltage amount 220 that is less than maximum voltage/full capacity 230, ultimately resulting in a reduced amount of stored energy at the completion of the current charge cycle, but an amount that is still more than the end-user is predicted to require during the next discharge cycle immediately following the current charge cycle. Also note that full capacity 230 may be slightly less than absolute max voltage potential for safety.

Then once the first voltage amount 220 is reached, chart 200 further illustrates that charge current may be gradually reduced to relax the battery cell(s) and maintain them at the target voltage amount.

Chart 250 illustrates that in addition to or in lieu of reducing the charge voltage for a given charge cycle below max SOC, the time at high voltage may also be reduced for even greater battery preservation. Accordingly, chart 250 again illustrates that constant current may be applied during the early stages of the charge cycle. But here, however, once the target voltage amount is reached, current may be reduced and then the battery may be disconnected from the charge circuit to stop charge current altogether. This allows the battery to begin to drain rather than stay at the target voltage amount, which again might be lower than max voltage but still relatively high depending on the dictates of the user's battery usage history.

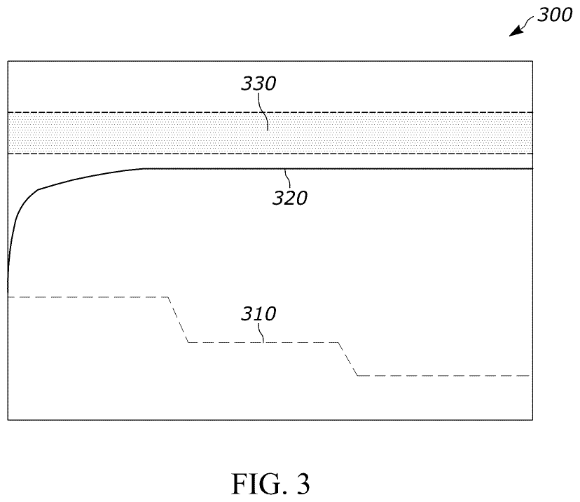

FIG. 3 also illustrates present principles via another chart 300 that demonstrates a smart charging algorithm for multistage constant current. Here, charge current 310 may be reduced in increments over time until the target voltage amount 320 is reached. The target voltage amount may correspond to a state of charge at completion of charging having an amount that is greater than an actual amount of battery charge the user is predicted to utilize during an upcoming discharge cycle.

As shown in FIG. 3, the target voltage amount 320 is still less than a buffer zone 330, the lower limit of which the battery might otherwise be charged to absent present principles. But in the present instance, the target amount correlates to approximately five percent less SOC than the lower limit SOC of the buffer zone 330. Here again it may be appreciated that by keeping battery voltage at or below the target amount (that is itself below the buffer zone 330), the longevity of the battery may be increased and battery swelling potentially mitigated.

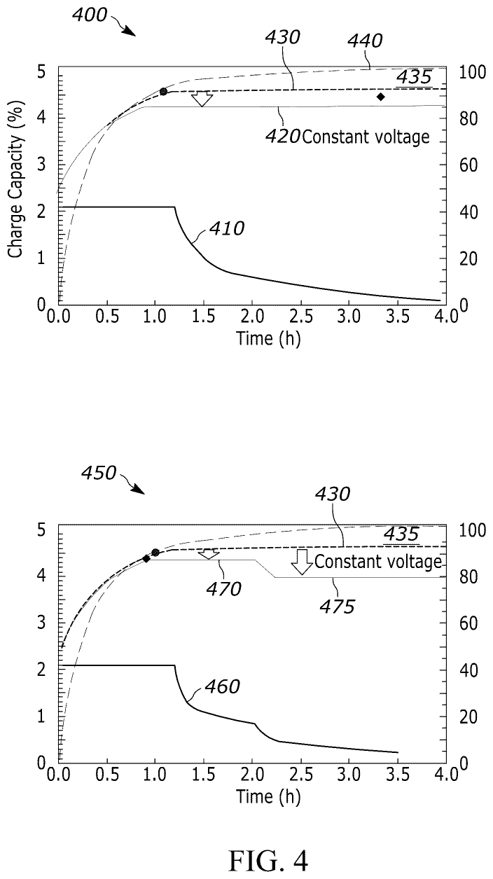

FIG. 4 shows two more example charts 400, 450 consistent with present principles. As shown in chart 400, current 410 may be applied constantly until a target voltage level 420 is reached, at which point current may be reduced. Constant voltage may then be maintained at the level 420 through the reduced (but still applied) charge current. It may be appreciated from FIG. 4 that the level 420 is again lower than a lower limit 430 of a buffer zone 435, with upper limit 440 establishing the upper limit of the buffer zone 435.

Chart 450 demonstrates that current 460 may be applied constantly during early stages of the charge cycle and then reduced in increments from there as time goes on. The increments may correspond to voltage amounts over time, with the battery being charged up to a first voltage 470 as shown based on a determination from battery usage history data that the battery should be charged up to the first voltage. Then responsive to the battery being connected to a charge circuit for longer than expected during the current charge cycle, the charge current may be reduced and the first voltage amount 470 may also be reduced to a second voltage amount 475. Note that both the first and second voltages 470, 475 are still lower than the lower bound 430 of the buffer zone 435. The battery may then be maintained at the second (lesser) voltage 475.

This technique as illustrated by the chart 450 may be advantageous because it may help keep the battery at a target voltage level and corresponding resultant amount of stored energy that is still more than enough for the user in the subsequent discharge cycle (as predicted based on battery history usage data) while still reducing the voltage even further away from the buffer zone 435 when the battery is connected to the charge circuit for longer than expected during the current charge cycle (and hence the expected upcoming discharge cycle will span less time than anticipated).

Accordingly, it may be appreciated based on FIG. 4 that, rather than the battery cell being first charged by a constant current (CC) which is followed by float charging with a constant voltage (CV) equal to the maximum cell voltage, the device may either: (1) Reduce the max voltage (single drop) based on the reserve needed and user usage profile per chart 200, or (2) Reduce voltage even more (multi-drop) based on the reserve needed and customer usage profile. Either way, this keeps the target charge voltage lower than at max level as long as the runtime reserves suffice. But it still accounts for the user's usage patterns and affords enough battery power to have the maximum amount needed at runtime for a predicted future use during the next discharge cycle. The charts of FIG. 4 thus show charge profile optimization for CC/CV embodiments.

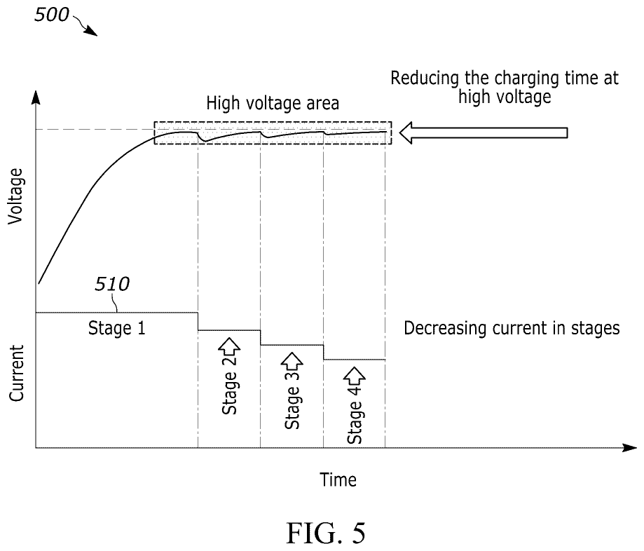

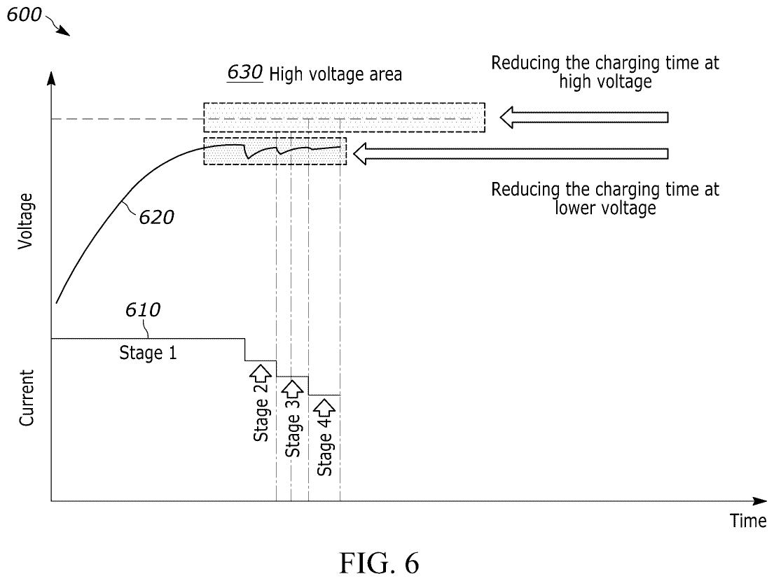

FIGS. 5 and 6 also demonstrate example smart charging algorithms for multistage constant current consistent with present principles. Beginning first with FIG. 5, a chart 500 is shown to illustrate one such algorithm. Here, current 510 may be reduced in stages from Stage 1 to Stage 4 over time. Stage 1 (highest current) may be used to charge the battery up to a first (target) voltage amount determined based on battery usage history as disclosed herein. Then the actual voltage may drop as the battery relaxes due to the current dropping to Stage 2. The battery may then slowly charge up to the target voltage level again using the Stage 2 current and responsive to reaching the target voltage level again the current may be dropped to Stage 3 level. This in turn results in additional battery relaxation and even discharge. So here again the battery may be slowly charged up to the target voltage level using the Stage 3 current and responsive to reaching the target voltage level yet again the current may be dropped once more to Stage 4 level. In this way, the battery may be kept at or near the target voltage level while still reducing total charging time at the target itself (while still remaining at a relatively high voltage that might be needed for an upcoming discharge cycle).

Continuing now in reference to FIG. 6, this figure shows yet another chart 600 illustrating present principles. Here again current 610 may be applied at different stages corresponding to progressively lower current levels, with Stage 1 current being used until the battery reaches a target voltage level determined from battery usage history data. The battery's voltage 620 may then be throttled back and forth to and below the target voltage level, but still consistently below a high voltage area 630, using the subsequent current stages similar to as described above.

Then responsive to the battery of FIG. 6 being connected to the charge circuit for longer than expected during the current charge cycle, at a time at the end of Stage 4 the battery may be disconnected from the charge circuit (or charging may otherwise be turned off). This may help reduce the SOC of the battery from that point forward, but this technique also still advantageously reduces the amount of charge time spent at both the target (first) voltage and even a lower second voltage that might still be relatively high as less than the target voltage level(s) will ultimately be needed in light of the unexpected extra charge time and delay in the start of the next discharge cycle.

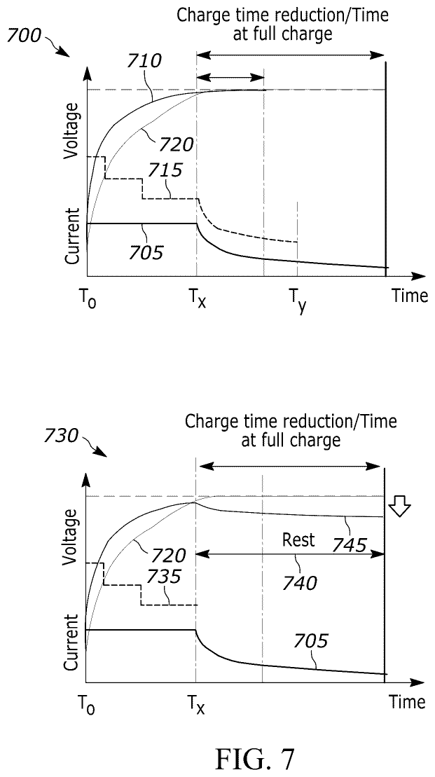

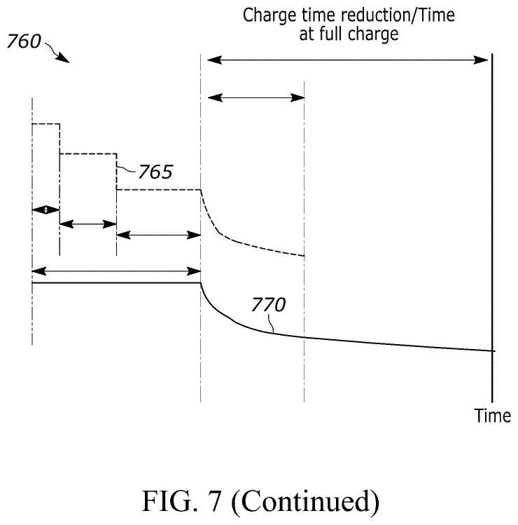

Now in reference to FIG. 7, three additional charts 700, 730, and 760 are shown to demonstrate an example modified multi-step constant fast charging algorithm that may be used even if the battery is to be charged up to full charge. For the chart 700, a lower constant charge current 705 and default voltage trajectory 720 may be replaced with a multi-stage current 715 that starts high to charge the battery faster initially but then decreases over time to still bring the battery to its target voltage. A tapering current may then be applied at time Tₓ. The charge current 715 may then be stopped completely at time T_{y} rather than continuing on per current 705. This technique may thus result in total charge time reduction as well as reduction in the total time the battery spends at full charge.

Chart 730 indicates another example to optimize battery charging to preserve battery integrity while still charging to full charge. Here, rather than using default current 705 to result in voltage trajectory 720, the device may instead use a multi-step decreasing current 735 beginning at time T₀ and ending at time Tₓ. From time Tₓ onwards, the battery may undergo rest and relaxation during rest timespan 740 with no charge current being applied. This in turn may cause the voltage 745 to drop below max potential voltage during the rest time, prioritizing battery health in the process. This technique may therefore also result in charge time reduction as well as total time the battery spends at full charge.

Chart 760 then demonstrates optimized multi-step current reduction 765 with different stages taking different amounts of time. Here, higher current amounts are used for less time than subsequent lower current amounts, enabling fast charging to reach a certain voltage to expedite charging but then dropping down to a lesser charge current shortly thereafter to reduce battery degradation that might otherwise occur from fast charging. This technique may therefore also result in additional charge time reduction and time the battery spends at full charge compared to application of non-optimal constant charge current 770.

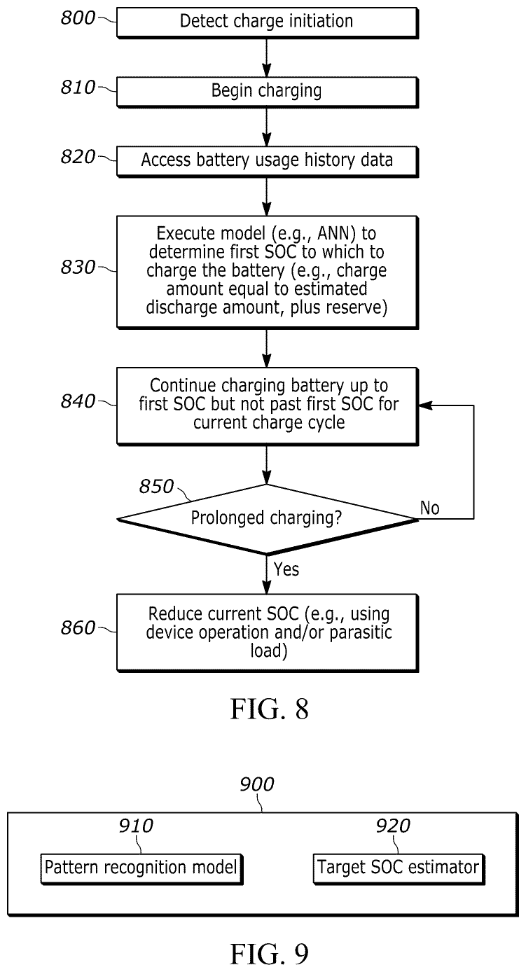

Referring now to FIG. 8, this figure shows example logic that may be executed by a processor system in a device such as the system 100, a smartphone or laptop computer, or another type of device. In one particular example, the logic may be executed by a battery management unit (BMU) processor in a battery management system (BMS) in the battery pack itself. Note that while the logic of FIG. 8 is shown in flow chart format, other suitable logic may also be used (e.g., state machine).

Beginning at block 800, the device may detect charge initiation, which might occur based on the user plugging the battery into a battery charger. The logic may then proceed to block 810 where the device may begin charging the battery at a default rate while performing ensuing steps in the logic.

Accordingly, at block 820 the device may access battery usage history data related to previous discharge cycles of the same battery. The history data may be stored in local persistent storage accessible to the processor system that is executing the logic of FIG. 8. As such, it may be stored in a solid state drive or hard disk drive accessible to a central processing unit (CPU) or microprocessor in the device. In one specific implementation, the battery history data may be stored in persistent storage within the battery's BMS for access by the BMU for examples where the BMU executes the logic of FIG. 8.

The battery usage history data may indicate a variety of different client device uses affecting battery discharge during different past discharge cycles. The data for device use may include, as an example, total runtime and power consumed for different applications (“apps”) executed at the client device during the relevant charge cycle. Other example data that may form part of the usage history includes length of time and battery discharge amount for discharge periods during which the client device is used for computer gaming and/or job-related activities. These are but examples and other types of data may also be included in the history consistent with present principles.

From block 820 the logic may next proceed to block 830. At block 830 the device may execute a model to determine a first (target) SOC/voltage amount to which to charge the battery that is less than full SOC to which the battery currently can be charged. The model may be a statistical model, an artificial neural network (ANN), and/or another type of model. Rules-based algorithms may also be used.

In one particular example, the model may be executed at block 830 to determine, based on one or more patterns recognized from the history data, a charge amount equal to an estimated discharge amount for a next or immediately upcoming discharge cycle, and add to that charge amount a reserve amount in excess of the charge amount itself. The reserve amount may be a static threshold amount that gets added each time, or may itself be dynamically determined based on possible device uses for the upcoming discharge cycle such that more reserve is added when device usage is expected to be heavier in the upcoming discharge cycle. For example, 10% SOC may be added as a reserve when the client device is predicted to be used only for word processing and Wi-Fi-based Internet browsing, but 30% SOC may be added as a reserve for the same discharge time when the client device is predicted to be possibly engaged in online gaming with livestreaming.

Additionally or alternatively, the reserve amount may be dynamically determined based on device confidence in its prediction of the estimated discharge amount for the upcoming discharge cycle, with the reserve amount progressively increasing as device confidence progressively decreases. Thus, if the device had a 90% confidence in its estimated discharge amount, the reserve may be another 10% SOC above a charge amount equaling the estimated discharge amount. But if the device had a 70% confidence in its estimated discharge amount, the reserve may be another 30% SOC above the charge amount.

Still in reference to FIG. 8, from block 830 the logic may then proceed to block 840. At block 840 the device may continue charging the battery up to the first (target) SOC but not past the first SOC for the current charge cycle. From block 840 the logic may proceed to decision diamond 850.

At diamond 850 the device may determine whether prolonged charging is occurring. For instance, at diamond 850 the device may determine whether the battery has been connected to its charge circuit for longer than expected during the current charge cycle. The expected charge cycle length itself may therefore also be determined based on the stored battery usage history data, with the data indicating different charge cycle times for different past charge cycles along with respective charge times of day and days of the week from which charge cycle patterns may be inferred using the same or a different model as the one executed at block 830.

A negative determination at diamond 850 may cause the logic to proceed back to block 840 where the battery may continue to be charged up to the first SOC for the current (uninterrupted) charge cycle. However, responsive to an affirmative determination at diamond 850 (e.g., that the battery has been connected to the charge circuit for longer than expected during the current charge cycle), the device may instead move to block 860 to reduce the SOC of the battery from the first SOC to a second SOC that is lower than the first SOC. And again note that both the first and second SOCs may be lower than a maximum possible SOC given the current decomposition state of the battery itself, and preferably below the buffer range also discussed above. Thus, in going from the first SOC to the second SOC, the device may further preserve battery material integrity by keeping the battery at an even lower voltage level that still meets the demands of the user for the upcoming discharge cycle.

As for how the device might reduce the SOC of the battery from the first SOC to the second SOC, the device may do this in one or more different ways. For instance, the device may disconnect the battery from the charge circuit for the battery to discharge via device operation (e.g., normal operating system operations that might be executed in the background while the user refrains from using the device). As another example, the device may additionally or alternatively control the battery's circuit(s) to apply a parasitic load to the battery to consume battery power. The device might therefore turn on a circuit switch to drain the battery to ground or to connect the battery to a light-emitting diode (LED) that might parasitically drain power from the battery.

Using the parasitic load may be particularly desirable in certain situations. For example, if the first (target) SOC is still relatively close to the buffer zone or max SOC (e.g., within five percent), then once the battery has been connected to the charge circuit for longer than expected and the first SOC amount becomes more than enough for the projected discharge amount for the next discharge cycle, the device may disconnect from the charge circuit and accelerate battery discharge even while the device is still be plugged into its charger as engaged with a power source like a wall outlet. This may be done to reduce the still relatively high first SOC to the second (safer) SOC even quicker to further minimize any possible battery damage.

Continuing the detailed description in reference to FIG. 9, example artificial intelligence (AI) architecture is shown for a machine learning (ML) model 900 that may be executed consistent with the logic of FIG. 8 and other disclosure above. However, note that the architecture 900 is but an example and that other AI architectures are also encompassed by present principles.

As shown in FIG. 9, the model 900 may include a pattern recognition model 910. The pattern recognition model 910 may be established by an artificial neural network (ANN) such as a feed forward neural network (FFNN), convolutional neural network (CNN), and/or other suitable pattern recognition model.

The model 900 may also include a target SOC estimator 920. The pattern recognition model 910 may therefore receive, as input, battery usage history data to then infer a battery usage pattern for an upcoming discharge cycle. The output from the model 910 may then be provided as input to the estimator 920, which may be an activation function of the model 910 or its own model that, in either case, outputs an inference of a target SOC (including reserve) to which to charge the battery that is lower than the maximum possible SOC to which the battery can be charged based on its current level of degradation or point in its lifecycle. If the estimator 920 is a separate model, it may be embodied as a classifier model such as a decision tree, k-nearest neighbor, support vector machine, etc.

Note that the ML model 900 may be trained using supervised learning and other machine learning techniques. In one particular example, the ML model 900 may be trained through supervised learning using a dataset that includes respective pairs of battery history usage patterns and a respective ground truth label for target SOC.

Unsupervised clustering algorithms may also be used to train the model 900 to output target SOCs that are a predefined or dynamic reserve amount over predicted actual SOC needed. This may be done by clustering together similar battery use patterns for past discharge cycles to then select a target SOC that is similar to the SOCs used in the past for a cluster that is related to a pattern that is predicted again for the next discharge cycle. The target SOC might therefore be an average of the past SOCs from the cluster of similar instances from the past.

It may therefore be appreciated that in using such ML techniques, the model 900 may be trained to recognize battery usage patterns according to time of day, day of the week, day of the month, day of the year, etc. The model 900 may account for battery usage patterns based on app usage patterns over a given segment of time and/or particular time of day. In various examples, patterns identified from the battery usage data may relate to power consumption for Wi-Fi transceiver usage, global positioning system (GPS) transceiver usage, Bluetooth transceiver usage, etc. during respective past discharge cycles. And as indicated above, future battery usage inferences may also be based on expected power consumption for gaming usage of a device, job usage of the device, telephone communication and text message usage of the device, email and social media usage of the device, travel usage of the device, and other types of use of the device as determined from past patterns based on the history data.

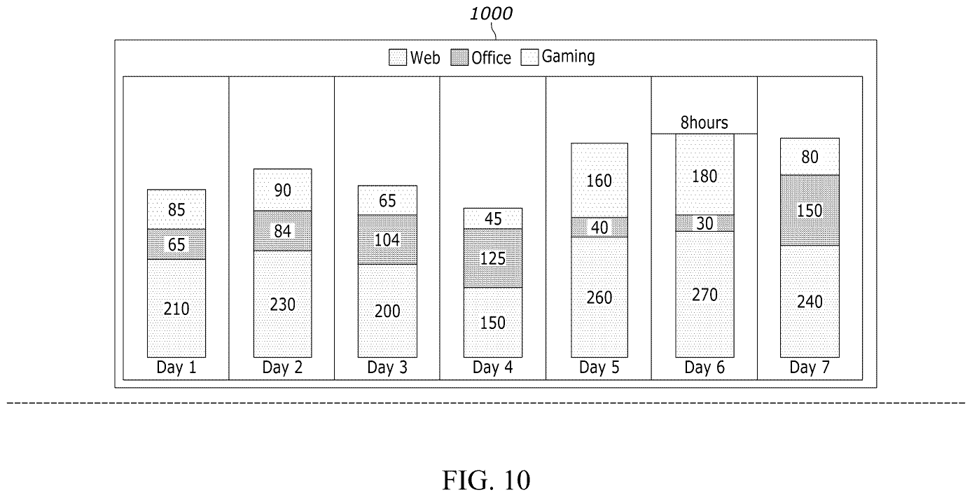

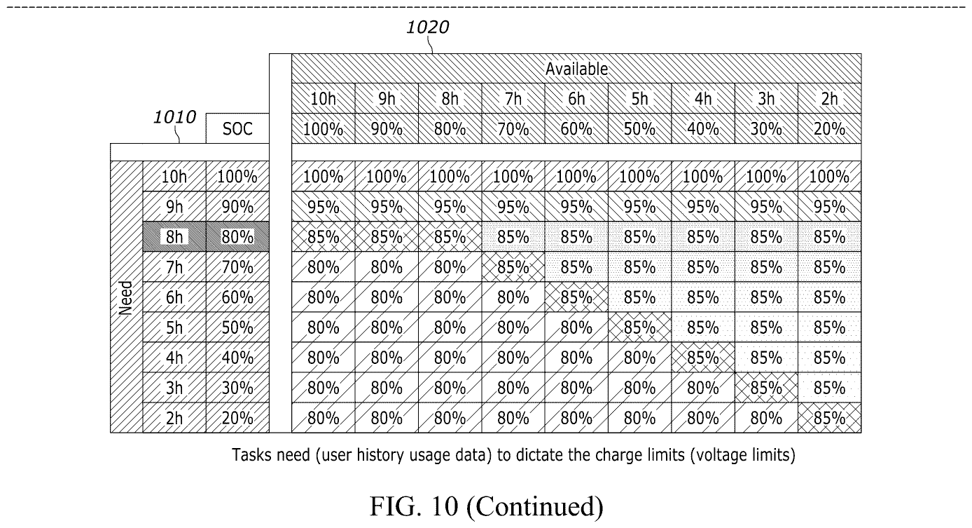

Turning to FIG. 10, an example chart is shown to further demonstrate present principles. Top inset 1000 illustrates a battery usage history over the seven most-recent days of the past week, with battery usage amounts for each day being broken down based on web browsing usage (bottom amount for each vertical bar), job/office usage (middle amount), and gaming usage (top amount). Left-side chart 1010 indicates target SOCs needed for respective amounts of time for a predicted future discharge cycle during which the battery will continuously not be connected to a charge source.

The X axis of the main chart 1020 then illustrates available charge amount over a decreasing amount of time until the next charge cycle (from left to right). The rows of the chart 1010 are also juxtaposed with the rows of the chart 1020 to illustrate that as the number of hours needed for a current discharge cycle comes down (a next charge time is upcoming), the charge demand in the chart 1010 also comes down even if the actual SOC available per the chart 1020 is more than that (but still less than 100% SOC). Thus, a reserve may be kept as time goes on so that if the next charge cycle is skipped or delayed, or the user simply uses the device more than expected, the battery has additional voltage to compensate. But the battery is still not charged to 100% over the combined charge/discharge cycle even if enough uninterrupted charge time was available to reach 100% SOC for that charge cycle.

Accordingly, it may be appreciated from FIG. 10 that user task needs as indicated in user history usage data for the last seven days may be used to determine the target SOC/voltage limits of a given charge cycle. In the present example, eighty percent SOC for eight hours has been determined to be enough charge based on the history 1000, with the charging device adding another five percent to start as a reserve. But here, the user ended up not using their battery much at all, and so even at two hours left until charging per the bottom right box in the chart 1020, the battery still has roughly 85% SOC remaining.

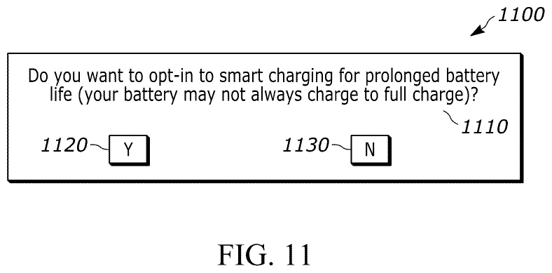

Now in reference to FIG. 11, it is to be understood that in some examples an end-user may opt in to charging to target SOCs that are below a max SOC consistent with present principles. This allows the user to still charge to full charge if desired, but also allows the user to opt-in to mitigating battery degradation if the user so chooses. Providing the user with an opt-in option also informs the user of why the battery might not charge to full charge even if plugged in for an extended period of time, which might otherwise confuse the user as to why the battery did not reach full charge.

As shown in FIG. 11, a graphical user interface (GUI) 1100 may be presented on the display of a device housing the battery itself. For example, the GUI 1100 might be presented on the touch-enabled display of a smartphone or laptop computer. The GUI 1100 may be presented responsive to an initial power on after a point of sale. As another example, the GUI 1100 may be presented responsive to the user engaging the battery with a charge source (e.g., each time the battery is plugged into its charger).

The GUI 1100 may include a prompt 1110 asking the user whether the user wants to opt-in to smart charging to prolong the device's battery life. The prompt 1110 may further inform the user that the battery may not charge to full charge potential. The user may then opt-in by selecting the “yes” selector 1120 or opt-out by selecting the “no” selector 1130.

It may now be appreciated that present principles provide for improved battery charging techniques to provide technical improvements to battery technology, minimizing battery degradation as much as possible while helping mitigate any possible battery cell swelling that might otherwise occur (or at least occur sooner absent present principles). The disclosed concepts are rooted in computer technology for computers to carry out their functions.

Components included in one embodiment can be used in other embodiments in any appropriate combination. For example, any of the various components described herein and/or depicted in the Figures may be combined, interchanged or excluded from other embodiments.

It is to be understood that whilst present principles have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

What is claimed is:

1. A device, comprising:
a battery;
a processor system; and
storage accessible to the processor system and comprising instructions executable by the processor system to:
execute a trained model to determine, based on battery usage history data, a first state of charge (SOC) to which to charge the battery, the first SOC being less than a full SOC for the battery; and
based on the determination, charge cells of the battery to a first voltage corresponding to the first SOC, the first voltage being less than a second voltage corresponding to the full SOC for the battery.

2. The device of claim 1, wherein the trained model comprises a trained pattern recognition model.

3. The device of claim 2, wherein the trained model is trained to recognize battery usage patterns according to time of day.

4. The device of claim 2, wherein the trained model is trained to recognize battery usage patterns according to day of the week.

5. The device of claim 2, wherein the trained model is trained to recognize battery usage patterns based on application usage patterns.

6. The device of claim 2, wherein the trained model comprises an artificial neural network.

7. The device of claim 1, wherein the trained model is trained to determine the first SOC to include both of: a first charge amount equal to an estimated discharge amount for an upcoming discharge cycle, and a reserve charge amount in excess of the first charge amount.

8. The device of claim 1, wherein the instructions are executable to:
responsive to the battery being connected to a charge circuit for longer than expected during the first charge cycle, reduce the SOC of the battery from the first SOC to a second SOC.

9. The device of claim 8, wherein the instructions are executable to:
reduce the SOC of the battery from the first SOC to the second SOC by disconnecting the battery from the charge circuit for the battery to discharge via device operation.

10. The device of claim 8, wherein the instructions are executable to:
reduce the SOC of the battery from the first SOC to the second SOC by applying a parasitic load to the battery to consume battery power.

11. A method, comprising:
determining, based on battery usage history data, a first state of charge (SOC) to which to charge a battery, the first SOC being less than full SOC; and
based on the determination, charging cells of the battery to a first voltage corresponding to the first SOC but not past the first SOC for a first charge cycle.

12. The method of claim 11, comprising:
executing a trained model to determine the first SOC.

13. The method of claim 12, wherein the trained model comprises one or more of: a feed forward neural network, a convolutional neural network.

14. The method of claim 11, wherein the battery usage history data is related to one or more of: power consumption for Wi-Fi transceiver usage, power consumption for global positioning system (GPS) transceiver usage.

15. The method of claim 11, wherein the battery usage history data is related to one or more of: power consumption for gaming usage of a device, power consumption for job usage of the device.

16. An apparatus, comprising:
at least one computer readable storage medium (CRSM) that is not a transitory signal, the at least one CRSM comprising instructions executable by a processor system to:
determine, based on battery usage history data, a first voltage that is less than full voltage to which to charge a battery; and
based on the determination, charge the battery to the first voltage but not past the first voltage for a first uninterrupted charge cycle.

17. The apparatus of claim 16, wherein the instructions are executable to:
determine the first voltage as including a reserve charge amount in excess of a first charge amount equal to an estimated discharge amount for an upcoming discharge cycle.

18. The apparatus of claim 16, wherein the instructions are executable to:
execute a pattern recognition model to make the determination.

19. The apparatus of claim 16, comprising the battery.

20. The apparatus of claim 19, wherein the battery is embodied as a battery pack of a laptop computer.
